(19) United States
(12) Patent Application Publication
(10) Pub. No.: US 2009/0100106 A1
(43) Pub. Date: Apr. 16, 2009

(54) System and Method for Securely Storing Wirelessly Transmitted Text, Images and Video

(76) Inventors: Marcus ANTHONY, Greensburg, PA (US); Scott BULLENS, Naples, FL (US)

Correspondence Address: THE WEBB LAW FIRM, P.C., 700 KOPPERS BUILDING, 436 SEVENTH AVENUE, PITTSBURGH, PA, 15219, US

(21) Appl. No.: 12/248,680

(22) Filed: Oct. 9, 2008

Related U.S. Application Data
(60) Provisional application No. 60/979,544, filed on Oct. 12, 2007.

(51) Int. Cl. G06F 7/00; G06F 17/00; G06F 21/22; G06F 15/16

(52) U.S. Cl. 707/104.1; 707/100; 709/206; 726/3; 707/E17.005; 707/E17.019

(57) ABSTRACT

A method for securely storing photos or videos wirelessly received from a mobile communication device includes the steps of (a) establishing at a service provider a user identifier associated with a user of the mobile communication device; (b) receiving at the service provider a photo or video transmitted from the mobile communication device; (c) establishing a time stamp for the photo or video; (d) associating the time stamp and the photo or video with the user identifier and storing the time stamp and the photo or video in a database of the service provider; (e) preventing the user from viewing the photo or video stored in the database; and (f) providing access to the photo or video to an authorized third party. A system for implementing the aforementioned method includes appropriate communicatively connected hardware components.

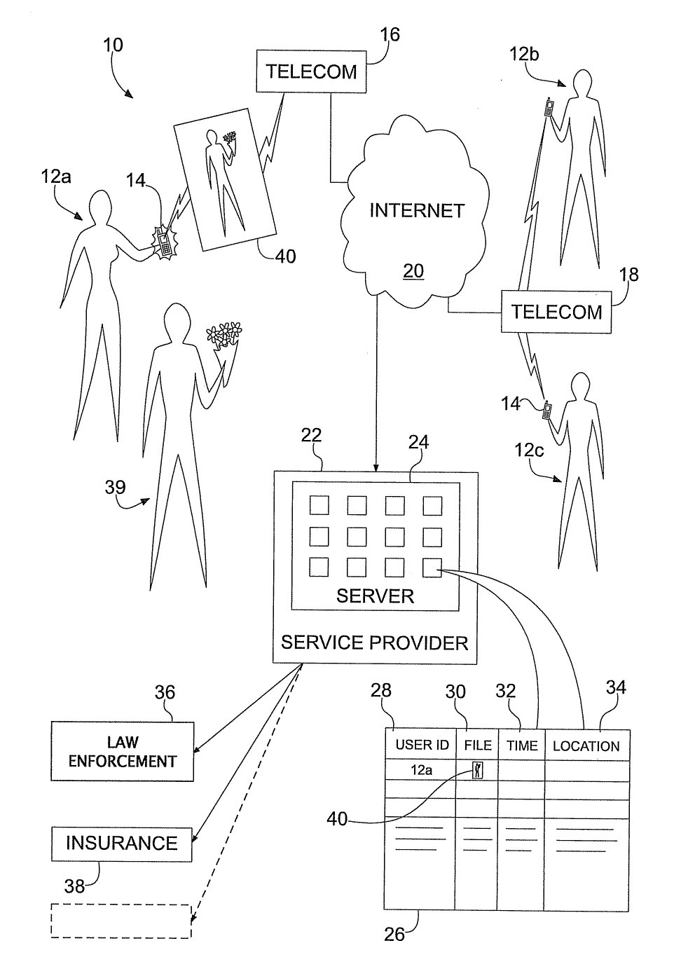

### CROSS REFERENCE TO RELATED APPLICATIONS

This application claims the benefit of U.S. Provisional Patent Application No. 60/979,544 filed Oct. 12, 2007, and entitled “System and Method for Securely Storing Cellular Phone Images and Video,” the contents of which are incorporated herein by reference.

### BACKGROUND OF THE INVENTION

1. Field of the Invention

The present invention relates to a system and method for storage of wirelessly transmitted text, image, and video and, more particularly, to providing a service provider for the secure archival of such text, image, and video for future release to authorized parties.

2. Description of Related Art

Mobile communication devices (MCD), include but are not limited to cellular telephones (including smart phones), personal/portable digital assistants, notebook/laptop computers, cameras, portable gaming consoles, and other network connection capable devices configured to capture and transmit various forms of data. For example, a multimedia cell phone may offer text messaging, photo/audio/video capturing, voice mail, and email services.

The aforementioned features of MCDs have primarily been utilized in the context of a person-to-person communications space. It would be desirable to harness the inherent data capture and transmission functionality of MCDs for useful purposes beyond the aforementioned person-to-person communications space.

### SUMMARY OF THE INVENTION

Accordingly, the present invention includes a system and method for secure archival storage at a remote service provider of text, images, audio, and video, and optionally data (e.g., meta data) related thereto, transmitted from a MCD. By virtue of being securely stored, the data will have a time stamp associated therewith, which is indicative of the relative time at which the data was transmitted from the MCD. The data may be stored in a manner that prevents alteration, controls access, and creates a verifiable unbiased chain of custodianship. These aspects attribute evidentiary value to the data with respect to its content, time of transmission/receipt, and optionally, location of transmission. Accordingly, the transmitted, and now stored data, may be relied upon as evidence to varying degrees in the context of different applications.

The present invention facilitates the ability for users (e.g., individuals, organizations) of MCDs to store information such as text messages, photos, video, voice mail, email and attachments, sent from these devices to a repository for the purpose of evidentiary record keeping with regard to time and content. In the event this aforementioned data becomes relevant at a future time, the data may be released by the repository to the users themselves, law enforcement, or the courts, for the purpose of resolving a dispute, complaint, investigation, etc. It is to be understood that the data may also be released if the user is incapacitated or deceased. Retrieval of the data will be possible despite the loss/disappearance of the MCD and/or the user. Under a previously agreed upon sequence of events and/or a formal request, data, such as last photos, video, text message, and last location of MCD, may be rapidly released to law enforcement and/or the courts in order to assist in a time sensitive situation involving the security or safety of an individual or organization. Release of the data may be overseen via an authorizing credential process, such as the issuance of a subpoena/warrant and/or providing direct/controlled access to pre-authorized entities (e.g., State Patrol, Fusion Centers), for example.

Desirably, the present invention provides for the transmitted information to be accessed only by law enforcement, the courts, or by formal request of the user. In other words, the information is not intended to be available for public viewing or entertainment, as would be the case with publicly accessible online media storage services. In the event the user is not available, law enforcement and/or the courts may request all data transmitted by the user to assist in finding the user, or question another individual who may be involved with or have knowledge of a crime against the user.

Users may send data such as photos, video, text messages, etc., with regards to any person the user believes threatens them in any manner. The photos or video will act as a record of when and where the MCD travelled and who was near the MCD at that time and place of transmission of the photos or video. Furthermore, the act of the user sending a photo or video of a possible perpetrator may serve as a deterrent against an actual crime being committed. Since the photos and/or video no longer remain exclusively on the device and the user does not have the ability to view or remove the data from the remote archival storage location, the ability of the perpetrator to commit a crime and remain anonymous has been reduced or eliminated. In the event the user is harmed or missing, law enforcement and/or the courts can access the photos and/or video in order to facilitate capture and prosecution of the perpetrator.

Accordingly, in one embodiment of the present invention, a method for securely storing photos or videos wirelessly received from a mobile communication device, wherein the method includes the steps of (a) establishing at a service provider a user identifier associated with a user of the mobile communication device; (b) receiving at the service provider a photo or video transmitted from the mobile communication device; (c) establishing a time stamp for the photo or video; (d) associating the time stamp and the photo or video with the user identifier and storing the time stamp and the photo or video in a database of the service provider; (e) preventing the user from viewing the photo or video stored in the database; and (f) providing access to the photo or video to an authorized third party. A system for implementing the aforementioned method includes appropriate communicatively connected hardware components.

The user identifier may include at least the phone number or network identifier of the mobile communication device. An email address may be assigned to the user. The photo or video received from the mobile communication device may be in the form of an email containing the email address of the user. The email address associated with the email may include the user identifier and a domain name associated with the service provider. The time stamp may correspond to either the date and time of receipt of the photo or video by the service provider, or the date and time of transmission of the photo or video to the service provider.

The third party may be a law enforcement agency. The law enforcement agency may be considered to be authorized by presentation of an authorizing credential by the law enforcement agency to the service provider. The authorizing credential may be a court order, such as a subpoena or a warrant. The third party may be considered to be authorized by being a pre-authorized government entity communicatively connected to the database of the service provider.

The method may further include the steps of receiving location data from the mobile communication device. The location data may correspond to the location of the mobile communication device at the time of transmission of the photo or video therefrom. The location data may then be associated with the photo or video and stored in the database. The location may be derived from a GPS unit associated with the mobile communication device, a triangulation calculation, a user-entered location, or any other suitable method.

In one embodiment of the present invention, a system for securely storing photos or videos wirelessly received from a mobile communication device includes (a) a subscription server configured to establish a user identifier associated with a user of the mobile communication cell phone; (b) a processing server communicatively connected to the subscription server and configured to: (i) receive a photo or video transmitted from the mobile communication device; (ii) establish a time stamp for the photo or video, wherein the time stamp corresponds to the date and time of receipt of the photo or video; and (iii) associate the time stamp and the photo or video with the user identifier; (c) a storage server communicatively connected to the processing server and configured to store the time stamp and the photo or video in a database of the storage server. The processing server may be further configured to receive the aforementioned location data, whereas the storage server may be further configured to store the location data in the database. The system may include a government entity-operated computer communicatively connected to the processing server, wherein the government entity-operated computer is configured to access the photo or video and the time stamp stored on the storage server.

Still other desirable features of the invention will become apparent to those of ordinary skill in the art upon reading and understanding the following detailed description, taken with the accompanying drawing, wherein like reference numerals represent like elements throughout.

### BRIEF DESCRIPTION OF THE DRAWING

The FIGURE is a schematic, illustrating the entities and the communicative relations therebetween in a system for wirelessly transmitting data and securely storing such data, in accordance with the present invention.

### DESCRIPTION OF THE PREFERRED EMBODIMENTS

The present invention will now be described with reference to the accompanying FIGURE. It is to be understood that the specific system illustrated in the attached FIGURE and described in the following specification is simply an exemplary embodiment of the present invention. Hence, specific dimensions and other physical characteristics related to the embodiments disclosed herein are not to be considered as limiting.

The FIGURE depicts a system 10 for storing data received from a user's MCD. In a desirable embodiment, the system 10 includes one or more users 12a, 12b, 12c, each possessing a MCD 14 or other suitable telecommunications device. Each MCD 14 of each respective user 12a, 12b, 12c is configured to connect to a telecommunications carrier or network access provider, such as telecom 16 and 18. Each telecom 16, 18 is connected to a distributed communications network, such as the Internet 20. Accordingly, each MCD 14 is able to transmit its captured data (e.g., photo, video) onto the Internet, via addressing and routing schemes, as is known in the art. It is to be understood that the MCD 14 may directly connect to various networks including Wi-Fi networks. Thus, it may not be necessary that the MCD 14 connect to a cell-based network used by cell phones, as network connectivity is already present in the Wi-Fi network due to its inherent TCP/IP implementation.

A service provider 22 is connected to the Internet 20. The service provider 22 serves as the remote storage or archival site for the captured data transmitted from each of the MCDs 14. Accordingly, the service provider 22 includes a server 24 configured to store the received captured data. In a desirable embodiment, the server 24 is arranged to store the captured data in the form of a record 26 having a plurality of fields for the storage of the captured data and associated information. For example, such fields may include, but are not limited to a user ID field 28 for holding information corresponding to the user 12a, 12b, 12c who transmitted the captured data, a file field 30 for holding the captured data (e.g., image, video, etc.) or a pointer thereto, a date/time stamp field 32 for holding information corresponding to the date/time of receipt of the data by the service provider 22, and optionally, a location information field 34 for holding information representative of the location of the MCD 14 at the time of transmission of the captured data. It is to be understood that any other suitable database structures may be implemented to store any of the aforementioned data. The service provider 22 may make the stored data available to various sources, such as law enforcement 36 and insurance companies 38, for evidentiary or corroboration purposes, for example, either at the request of the user 12a, 12b, 12c who transmitted the captured data, or by a court order or other authorization mandate. The database is desirably secure and not subject to unauthorized modification of the stored user-transmitted pictures, video, and text, and also the ancillary data, such as the date/time stamp information. Due to the inability to alter the data, the data can be considered to be accurate and untainted, which is conducive to satisfying chain of custody or other evidentiary proof issues.

The present invention will now be discussed according to one embodiment of its operation. The user 12a may access a website (not shown) associated with the service provider 22 for purposes of subscribing or registering for the use of the system 10. It is to be understood that the website responsible for user registration may be separate from the server 24 responsible for storing the MCD 14 transmitted data. For example, the system 10 may be compartmentalized into registration servers, processing servers, and storage servers, which may or may not be physically located in the same geographic location. The user 12a may be asked for their name, cell phone number, and email address, along with various other demographic information including, but not limited to, their age/date of birth, home zip code, occupation, employer zip code, hobbies, travel patterns, cell phone carrier, and cell phone type. This information is then recorded by the service provider 22 and may be shared with marketing or advertising partners for purposes of subsidizing the system 10. Thus, in the context of an advertiser sponsored system, on a periodic basis (e.g., two times a month), a message may be sent to the user's phone and/or email address promoting an advertiser's goods or services. The message may be tailored to a user's particular interests based upon the registration information provided by the user. Alternatively, or in combination with the aforementioned advertising model, the system 10 may be in the form of a fee-based service in which the user 12a pays a monthly fee.

During the registration process, the user may also be presented with any necessary privacy disclaimers or service policies applicable to use of the system 10. For example, the user 12a may be asked to confirm the allowance of a certain number of monthly advertisements that would be sent to the user's cell phone 14. The user 12a may be assigned a user ID that is associated with the phone number of the cell phone 14 of the user 12a. The user ID may be the number of the cell phone 14 of the user 12a. The user ID may also be used by the user 12a to log in to the web site to update various preferences. To allow for easier memorization, the user ID, being the user's phone number, may be paired with a domain name associated with the service provider 22 (e.g., 1234567890@mymobilewitness.com) to constitute the email address to which the user 12a would transmit any captured content via their cell phone 14. An exemplary cellular message transmission standard is Multimedia Messaging Service (MMS), which provides for sending messages that include multimedia objects (e.g., images, audio, video) from a cell phone. In the case of using MMS, the phone number of the MCD 14 is inherently associated with the transmission, thereby assuring that the image or video received was in fact transmitted from that particular MCD 14. In the case that an MCD 14 does not utilize a cell phone network, but rather connects directly via a TCP/IP connection or other packet-switched network, the user ID may be a hardware address of the MCD 14, an assigned network address, or other suitable identifier. In other words, the service provider 22 associates some sort of identifier that uniquely identifies the user and/or their MCD 14.

Accordingly, the server 24 is configured to accept transmissions of captured images sent by the user 12a to the assigned email address or other predetermined (via an earlier registration) number or network identifier. In contrast, the transmission of captured data sent by unregistered users may not be stored on the server 24 and may therefore be discarded by the service provider 22. In an alternative embodiment, the service provider 22, in response to receiving captured data sent by unregistered users, may transmit a text message or other communication to the unregistered user's MCD 14 informing the user that registration with the service provider 22 is a prerequisite to storing of transmitted data. The server 24 may be configured to delete captured data after a set period of time from the date of receipt thereof. For example, a six-month deletion period would provide a reasonable time frame in which any inquiry into the captured data would have occurred.

There are many practical applications for transmission and secure storage of wirelessly transmitted data from MCDs 14. For example, the user 12a may decide to go on a blind date with another individual 39. Since the user 12a does not know any personal information concerning the individual 39, she may be rightfully concerned about her safety and, therefore, decides to take a photo 40 of the individual 39 with the camera of the cell phone 14 at the beginning of the date. The photo 40 is then transmitted via the telecom 16, through the Internet 20, to the service provider 22, where it is stored within the server 24 in the record 26 in the field 30, along with other associated information. As discussed above, the act of taking a photo 40 and mentioning to the individual 39 that a photo 40 has been sent to the service provider 22, may act as a deterrent against any planned crime against the user 12a. Alternatively, in the unfortunate instance that a crime has been committed against the user 12a, the service provider 22 may release the photo 40 and associated information to law enforcement 36 for purposes of questioning the individual 39 and possibly considering the individual 39 as a suspect with respect to any crime perpetrated against the user 12a.

It is to be understood that various MCDs 14 may be used in connection with the present invention. Accordingly, it is to be understood that the present invention may account for various communication protocols (e.g., GSM, CDMA), operating platforms (e.g., Java, Symbian OS), data formats (JPEG, TIFF, AVI), etc. utilized by and associated with each MCD 14 and underlying telecommunication carriers 16 and 18.

It is to be understood that the MCD 14 used in connection with the present invention may include a simplified capture/transmission interface that allows a user to quickly and efficiently obtain the data, whether it be a photo or video, and transmit the data to the server 24. For example, a cell phone 14 may be equipped with a one-touch button and necessary software implementation to allow a user to push the button to cause the cell phone's camera to obtain a picture, which is then transmitted to a predetermined IP address or other network identifier corresponding to the server 24. Alternatively, a software overlay application or macro may be loaded onto the MCD 14 that maps existing cell phone buttons to the capture and transmission functionality. Use of such a MCD 14 provides for the quick transfer of photos or video from the MCD 14 to a secure location, as discussed above. Accordingly, in an emergency situation, for example, a user is able to quickly capture, transmit, and have remotely stored a photo or video without concern that the photo or video may not be retrievable from the MCD 14 in the event the MCD 14 is lost, destroyed, damaged or stolen after the image or video in question was captured.

The present invention may be used in the context of various applications including, but not limited to law enforcement, personal security, and insurance. The following are but a few examples for use of the present invention.

With respect to the law enforcement application, an officer may use the present invention to submit photographic or video evidence obtained at an event or scene. If the evidence were called into question with respect to any chain of evidence violations, the evidence transmitted to the service provider 22 may be compared to the evidence called into question. Certain law enforcement agencies, such as Fusion centers, may be recognized by the service provider 22 as pre-authorized entities that are granted a direct communications connection to the server 24 of the service provider 22. In another embodiment, Fusion centers, or agencies, such as the Department of Homeland Security, may have unlimited real-time access to the databases storing the transmitted pictures or video, which would allow them to perform data analysis (e.g., facial recognition) on the data for the purpose of furthering pending investigations that may not be related to the underlying reason for which the data was initially captured and transmitted to the service provider 22.

With respect to the personal security application, when live video is activated, the user and/or user's surroundings will be monitored and a record will be maintained. In the event of an incident, either observed by the monitoring party during video surveillance mode, or triggered by the user via a panic feature on the MCD 14, for example, assistance may be sent to the location of the MCD 14 (utilizing GPS transmission capabilities of the MCD 14). In the event that the user is no longer with the MCD 14, the last photos or videos will be referenced along with the history of the MCD's location or locations that coincide with the photo or video evidence.

With respect to the insurance application, an adjuster and/or claimants may send photos or video of an incident or belongings as a record of how an event or place looked at a specific time. Information stored in this manner would confirm an uninterrupted chain of custodianship. Adjusters or claimants may want two copies (i.e., one they possess and one that the service provider 22 maintains) of photos or video taken with MCDs 14 in case authenticity of any photo or video is questioned. With the use of GPS, both time and place may be verified in addition to content.

Other non-limiting examples include a user planning on traveling into the wilderness, for hiking or mountain biking. The user may take a picture of a trailhead sign corresponding to the direction of travel of the user. Then, if anything were to happen to the user which necessitates the use of law enforcement, the service provider would release the images taken by that user. Law enforcement would then be able to see the picture with the trailhead, thereby providing them with valuable information that can be passed on to a search team. In another example, a user in a parking garage may take a picture of a license plate of a suspicious vehicle. In a further example, a user may take a picture of the plumber who responds to a plumbing call. Thus, as can be seen in the aforementioned examples, the present invention allows for a picture to be taken of someone or something as a precaution or deterrent.

It is to be understood that the present invention may be utilized in the context of other applications not specifically discussed herein. However, this is not to be considered as limiting the underlying functionality of the present invention, as the underlying functionality can be used with, adapted to, and/or expanded to meet the needs of other applications not specifically discussed herein. Furthermore, it is to be understood that the present invention may accommodate advances in technology. For example, the transmission of data to the service provider 22, such as video, may be streaming video. Thus, instead of first taking the video and then transmitting it, the user may stream the video in real time to the service provider 22. Of course, it is to be understood that accommodating this and other technological advances may require the appropriate underlying software and hardware (e.g., 3G phone, high speed network infrastructure).

Furthermore, the present invention has been described with reference to the desirable embodiments. Modifications and alterations will occur to others upon reading and understanding the preceding detailed description. It is intended that the present invention be construed as including all such modifications and alterations insofar as they come within the scope of the appended claims or the equivalents thereof.

The invention claimed is:

1. A method for securely storing photos or videos wirelessly received from a mobile communication device, the method comprising the steps of:
(a) establishing at a service provider a user identifier associated with a user of the mobile communication device;
(b) receiving at the service provider a photo or video transmitted from the mobile communication device;
(c) establishing a time stamp for the photo or video;
(d) associating the time stamp and the photo or video with the user identifier and storing the time stamp and the photo or video in a database of the service provider;
(e) preventing the user from viewing the photo or video stored in the database; and
(f) providing access to the photo or video to an authorized third party.

2. The method of claim 1, wherein the user identifier includes at least the phone number or network identifier of the mobile communication device.

3. The method of claim 1, further comprising the step of assigning an email address to the user, wherein the photo or video is received from the mobile communication device in the form of an email containing the email address of the user.

4. The method of claim 3, wherein the email address associated with the email includes the user identifier and a domain name associated with the service provider.

5. The method of claim 1, wherein the time stamp corresponds to one of:
the date and time of receipt of the photo or video by the service provider; and
the date and time of transmission of the photo or video to the service provider.

6. The method of claim 5, wherein the third party is a law enforcement agency.

7. The method of claim 6, wherein the law enforcement agency is authorized by presentation of an authorizing credential by the law enforcement agency to the service provider.

8. The method of claim 7, wherein the authorizing credential is a court order.

9. The method of claim 5, wherein the third party is authorized by being a pre-authorized government entity communicatively connected to the database of the service provider.

10. The method of claim 5, further comprising the steps of:
receiving location data from the mobile communication device, wherein the location data corresponds to the location of the mobile communication device at the time of transmission of the photo or video therefrom;
associating the location data with the photo or video; and
storing the location data in the database.

11. The method of claim 10, wherein the location is derived from one of:
a GPS unit associated with the mobile communication device;
a triangulation calculation; and
a user-entered location.

12. The method of claim 5, further comprising the step of automatically deleting the photo or video after a predetermined amount of time.

13. The method of claim 5, wherein the mobile communication device is one of: a cell phone, a personal digital assistant, a notebook/laptop computer, a camera, and a portable gaming console.

14. A method for securely storing photos wirelessly received from a cell phone, the method comprising the steps of:
(a) establishing at a service provider a user identifier associated with a user of the cell phone, wherein the user identifier includes at least the phone number of the cell phone;
(b) assigning an email address to the user, wherein the email address includes the user identifier and a domain name associated with the service provider;
(c) receiving at a service provider and MMS message or email from the cell phone, wherein the MMS message or email contains the email address of the user and the photo;
(d) establishing a time stamp for the photo, wherein the time stamp corresponds to the time of receipt of the photo by the service provider;
(e) associating the time stamp and the photo with the user identifier and storing the time stamp and the photo in a database of the service provider;
(f) preventing the user from viewing the photo stored in the database;
(g) providing the photo and the time stamp to a law enforcement agency after presentation of an authorizing credential by the law enforcement agency to the service provider; and
(h) automatically deleting the photo after a predetermined amount of time without instruction by the user for the deletion of the photo.

15. The method of claim 14, further comprising the steps of:
receiving location data from the cell phone, wherein the location data corresponds to the location of the cell phone at the time of transmission of the photo or video therefrom;
associating the location data with the photo; and
storing the location data in the database.

16. The method of claim 14, wherein the authorizing credential is a court order.

17. A system for securely storing photos or videos wirelessly received from a mobile communication device, the system comprising:
(a) a subscription server configured to establish a user identifier associated with a user of the mobile communication cell phone;
(b) a processing server communicatively connected to the subscription server and configured to:
(i) receive a photo or video transmitted from the mobile communication device;
(ii) establish a time stamp for the photo or video, wherein the time stamp corresponds to the date and time of receipt of the photo or video; and
(iii) associate the time stamp and the photo or video with the user identifier; and
(c) a storage server communicatively connected to the processing server and configured to store the time stamp and the photo or video in a database of the storage server.

18. The system of claim 17, wherein the processing server is further configured to receive location data from the mobile communication device, wherein the location data corresponds to the location of the mobile communication device at the time of transmission of the photo or video therefrom; and
associate the location data with the photo or video, and wherein the storage server is further configured to store the location data in the database.

19. The system of claim 17, further comprising a government entity-operated computer communicatively connected to the processing server, wherein the government entity-operated computer is configured to access the photo or video and the time stamp stored on the storage server.
